(19) United States
(12) Patent Application Publication
(10) Pub. No.: US 2022/0343279 A1
(43) Pub. Date: Oct. 27, 2022

(54) AUTHORING MANAGEMENT METHOD BASED ON RELATION OF ELECTRONIC DOCUMENTS AND AUTHORING MANAGEMENT SYSTEM

(71) Applicant: CHO, Young-hwa, Seoul (KR)

(72) Inventor: Young-Hwa CHO, Seoul (KR)

(21) Appl. No.: 17/764,417

(22) PCT Filed: Sep. 28, 2020
(86) PCT No.: PCT/KR2020/013166

§ 371 Date: Mar. 28, 2022

(30) Foreign Application Priority Data
Sep. 28, 2019 (KR) 10-2019-0120190

(51) Int. Cl. G06Q 10/10; G06F 40/169; G06F 40/117

(52) U.S. Cl. CPC G06Q 10/10; G06F 40/169; G06F 40/117

(57) ABSTRACT

An authoring management method includes: a content designated section setting step of setting a designated section in an electronic document; an RD authored content collection step of collecting first RD content and corresponding first mark-up information as first RD authored content; an identification information creation step of creating the identification information of the first RD authored content; a correlation collection step of collecting a correlation between the first RD authored content and another piece of RD authored content; a relation attribute collection step of collecting a relation attribute regarding the nature of a change between the first authored RD content and the other piece of authored RD content; an RD creation step of creating a first RD; and a storage step of storing the first RD in an RDDB and also storing the electronic document in an electronic document DB.

### BACKGROUND

The present invention relates generally to a relation-based authoring management method for electronic documents and an authoring management system, and more particularly to a relation-based authoring management method for electronic documents and an authoring management system, in which various types of RD authored content are configured to have correlations in an authored document creation area and three-dimensional relation attributes are set for the correlations, thereby allowing the RD authored content to be stored and managed as lively information.

In general, a word processor refers to software that is used to create, edit, store, and print documents. Such word processors are convenient not only when creating a new document, but also when retrieving an existing document and checking or modifying its content. Representative word processors are Microsoft Corporation's ‘MS Word^{R}’ and Hangul Co., Ltd.'s ‘Hangul^{R}.’ Such word processors are widely used for simple insertion or removal of images or tables as well as text, support for various fonts, graphics, multiple levels, and various colors. With the recent proliferation of Internet and cloud services, such word processors are developing into web offices. Such word processors have the challenges in which the sharing of electronic documents and collaboration on electronic documents are required, not only the creation or storage of documents but also easy access to created content are enabled anytime and anywhere, the sharing of a document with other persons or the cooperative creation of a document by multiple users (or authors) can be supported, or the mutual relations between documents or the content of documents can be easily understood. In accordance with such changes in the environment, a configuration management technology has been recently proposed.

The configuration management technology is a set of activities for managing the changes of a document, is intended for version management and version control, and is a scheme for applying software development or project management technology to electronic documents. A document management system based on this configuration management technology is proposed in Korean Patent No. 10-1884343 (title of the invention: Document Management System, Method and Terminal). Korean Patent No. 10-188433 proposes a document management system in which documents are managed in such a manner that documents are tracked using the identifiers of document items or in such a manner that a user having authoring authority creates keywords for document items in response to document management requests. The document management system has improved convenience because documents are tracked and managed by identifier or keyword search. However, in the case of this document management system, documents without keywords may be omitted because documents are output by keyword search, there is a limitation to determining organic relations because it is necessary to individually check and determine the mutual content between multiple documents, and a limitation is imposed and there is also a limitation to integrated document management because tracking information is created and managed by a person having separate creation authority.

### SUMMARY OF THE INVENTION

The present invention has been conceived to overcome the above-described problems, and an object of the present invention is to provide a relation-based authoring management method for electronic documents and an authoring management method for implementing the same, in which directional correlations are formed between pieces of RD authored content during the process of creating or editing electronic documents and three-dimensional relation attributes are defined for the correlations and managed as systematic data, thereby enabling effective monitoring, analysis, and verification through the organic relations between the pieces of RD authored content.

Another object of the present invention is to provide a relation-based authoring management method for an electronic document that systematically manages RD authored content over a network for sharing and collaboration, so that multiple users can use the RD authored content together, inspect and modify it, and complete a high-quality electronic document, and an authoring management method for implementing it.

In order to achieve these objects, as a preferred embodiment of the present invention, an authoring management method includes: a content designated section setting step of setting a designated section in an electronic document by an input key of an input device; an RD authored content collection step of collecting first RD content and corresponding first mark-up information located in the designated section as first RD authored content; an identification information creation step of creating the identification information of the first RD authored content; a correlation collection step of collecting a correlation between the first RD authored content and another piece of RD authored content; a relation attribute collection step of collecting a relation attribute regarding the nature of a change between the first authored RD content and the other piece of authored RD content; an RD creation step of creating a first RD by converting the first RD authored content, the identification information, the correlation, and the relation attribute into a dataset; and a storage step of storing the first RD in an RDDB and also storing the electronic document in an electronic document DB.

Furthermore, as a preferred embodiment of the present invention, there is disclosed an authoring management system including: an authoring module configured to create the RD content of an electronic document according to the input information of an input device; an RD definition module configured to allocate identification information to a designated section of the RD content and classify the RD content and corresponding mark-up information as RD authored content; a relation setting module configured to collect a correlation between the RD authored content and another piece of RD authored content and collect a relation attribute regarding the nature of a change between the RD authored content and the other piece of RD authored content; and a data processing module configured to create an RD by converting the RD authored content, the identification information, the correlation, and the relation attribute into a dataset and store the RD in an RDDB and the electronic document in an electronic document DB.

In the present invention, pieces of RD authored content created or being newly created according to changes in the thinking of an author form directional correlations with one or more other pieces of RD authored content and are mutually connected and attributes are also defined and managed as data, so that changes in the RD authored content of the author can be easily determined and understood and analysis and verification between pieces of RD authored content can be performed at all times based on the relation attributes.

Furthermore, changes in RD authored content can be fundamentally tracked, checked, modified, and supplemented without the need to generate and manage corresponding electronic documents as independent data files according to the changes in the RD authored content, and systematic creation and integrated management can be achieved based on the mutual organic relations between pieces of RD authored content.

Moreover, a data file is systematically created, stored, and managed such that multiple users can share, utilize, and collaborate on a single piece of RD authored content, so that users can complete high-quality RD authored content while referring to other users' RD authored content and opinions regardless of time and place for authoring.

### BRIEF DESCRIPTION OF DRAWINGS

FIG. 1 is a diagram illustrating the functional concept of an authoring management system in the form of systematic blocks as a preferred example according to the present invention;

FIG. 2 is a flowchart illustrating a process in which an authoring management system creates an RD and converts the generated RD into data in order to enable sharing and collaboration over a network as a preferred example according to the present invention;

FIG. 3 is a block diagram schematically showing an authoring management system as one preferred example according to the present invention;

FIG. 4 is a block diagram showing the data structure of an electronic document generated by an authoring management system as one embodiment according to the present invention;

FIG. 5 shows an image of the content of an electronic document including an RD created by an authoring management system as an example according to the present invention;

FIGS. 6 and 7 show source code for the RD authored content of the electronic document shown in FIG. 5 as an example according to the present invention;

FIGS. 8 and 9 show tables showing the RD authored content extracted from the source code of FIGS. 6 and 7 on a per-identification information basis as an example according to the present invention;

FIG. 10 is a flowchart showing a process in which an RD is generated on an electronic document as one preferred example according to the present invention;

FIG. 11 shows an electronic document task window in which an RD setting key is generated as one example according to the present invention;

FIG. 12 shows an electronic document task window in which a correlation collection window and a relation attribute collection window are popped up as one example according to the present invention;

FIG. 13 shows an electronic document task window in which a query window for querying whether or not to recommend a relation attribute and a relation attribute recommendation window are generated as one example according to the present invention;

FIG. 14 is a flowchart showing a process in which an RD is generated as content is created as one example according to the present invention;

FIG. 15 is a block diagram showing an authoring management system composed of a server-client system as a preferred example according to the present invention;

FIG. 16 is a flowchart showing a process in which RD authored content is collected as a preferred example according to the present invention;

FIGS. 17 and 18 show tables showing the configuration of RD content and corresponding mark-up information of RD authored content for the authoring management system to convert an RD into data as an example according to the present invention;

FIG. 19 is a flowchart illustrating a process in which a user searches for an RD stored in an RDDB for the purpose of sharing and collaboration in an authoring management system as an example according to the present invention;

FIG. 20 is a flowchart illustrating another implementation process in which a user searches for an RD stored in an RDDB for the purpose of sharing and collaboration in an authoring management system as an example according to the present invention;

FIG. 21 is a flowchart illustrating a process in which an author receives and works on an RD stored in an RDDB for the purpose of collaboration in an authoring management system as an example according to the present invention;

FIG. 22 shows the summary information of RDs as an example illustrating an authoring management method using RDs according to the present invention;

FIG. 23 is a diagram visually representing the summary information shown in FIG. 22 using nodes and edges;

FIG. 24 is a flowchart showing a process illustrating the relation attribute verification process of an authoring management system as a preferred example according to the present invention; and

FIG. 25 schematically shows a table of relation attributes and RD authored content of RDs as a preferred example according to the present invention.

### DETAILED DESCRIPTION OF THE INVENTION

In general, a word processor or document management system is implemented by a combination of hardware and software configurations. Hardware includes a central processing unit (CPU), a memory unit, an input-output unit, a controller, an arithmetic logic unit (ALU), a digital signal processor, a field programmable gate array (FPGA), a programmable logic unit (PLU), etc., and is implemented as one or more general-purpose computers or special-purpose computers. In addition, the processing unit drives an operating system (OS) or one or more applications executed on the OS, and accesses, stores, manipulates, processes, and generates data in response to the execution of software. Such a processing unit may be independently configured, but may include a plurality of processing elements and/or a plurality of types of processing elements. In addition, the software includes an operating system (OS), an input-output control program, and an application program, and allows a processing unit to be operated by a combination of a series of instructions. Software and/or data may be permanently or temporarily embodied via a physical or virtual device, a storage medium, or a transmitted signal wave by a processing unit, or may be distributed over a networked computer system and stored or executed in a distributed manner. Based on such hardware and/or software, a relation-based authoring management method or authoring management system according to the present invention can be implemented. Detailed descriptions of known general technologies will be omitted to ensure ease of description and understanding of components and to avoid unnecessary, redundant descriptions.

The relation-based authoring management method and authoring management system according to the present invention will be described in detail below with reference to the accompanying drawings. For the description of the present invention, terms such as ‘RD,’ ‘RD authored content,’ ‘identification information,’ ‘correlation,’ ‘relation attribute,’ ‘dataset,’ ‘conversion into data,’ ‘author,’ ‘sharing,’ ‘collaboration,’ and ‘user’ are used.

These terms are terms introduced to describe the features of the present invention, and are distinguished from general terms or terms used in other documents. For the sake of clarity, the terms used in the present invention will be defined as follows:

The ‘RD’ refers to a dataset including RD authored content, identification information, a correlation, and a relation attribute. The ‘RD’ is a term introduced for convenience of the description and understanding of the present invention. However, generally, a resource description (RD) is used as a term defining the standard of metadata descriptive of various information resources in a web environment. However, this is different from the term ‘RD’ used for the description of the present invention. They must be understood and interpreted separately from each other.

The ‘RD authored content’ refers to RD content, constituting the content of an electronic document, and corresponding mark-up information. In particular, the RD content may be various types of information such as text, an image, a table, a video, and a graph. Furthermore, the RD authored content according to the present invention refers to data itself, not a group in a specific format such as a file. The ‘RD authored content’ constitutes RD content, and a mark-up language (hereinafter ‘mark-up information’) defining the output format of the RD content.

The ‘identification information’ refers to information for distinguishing pieces of RD authored content from each other. In this case, this may be any one or a combination of an ID, which is an identification code, the title and type of an RD, and the size of an RD.

The ‘correlation’ refers to a relationship (a source or a target) present between pieces of RD authored content, including information about whether or not there is a connection. A piece of RD authored content may have a correlation with one or more other pieces of RD authored content.

The ‘relation attribute’ refers to the characteristic of a change between pieces of RD authored content having a correlation.

The ‘dataset’ refers to a dataset regarding RD authored content, identification information, a correlation, and a relation attribute.

The ‘conversion into data’ refers to the operation processing process of converting a RD dataset into data on a per-data basis rather than data on a per-file basis in a network communication environment and then storing the data on a per-data basis in a database of RDs (hereinafter the ‘RDDB’) and a database of electronic documents (hereinafter the ‘electronic document DB’) according to a designated process in order to enable sharing and collaboration.

The ‘author’ refers to a user who authored an electronic document using an authoring management system.

The ‘sharing’ refers to the act by which another network-connected sharer refers to and uses an RD created by an author, and the authoring management system sets up a data environment for the sharing.

The ‘collaboration’ refers to the act by which another collaborator connected over a network modifies an RD authored and created by an author and sends the modified RD to the author and the author applies his or her style to the RD content of the RD modified by the collaborator and notifies the collaborator of whether or not to use it in an electronic document. The authoring management system sets up a data environment for the collaboration.

The ‘user’ refers to a collaborator or a sharer.

The ‘user’ collectively refers to a user and an author.

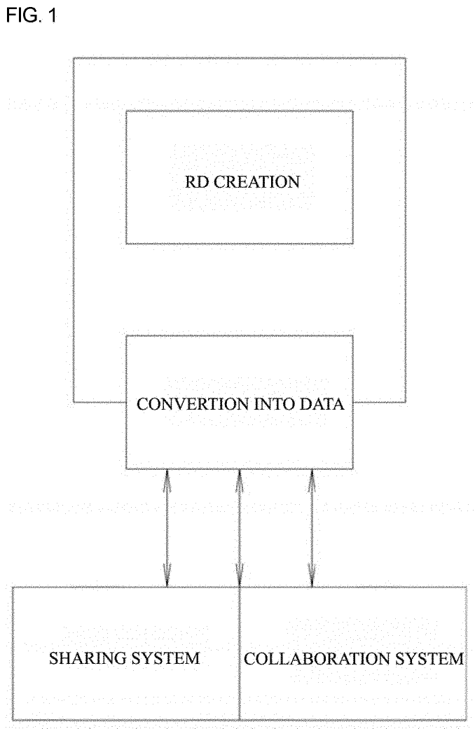

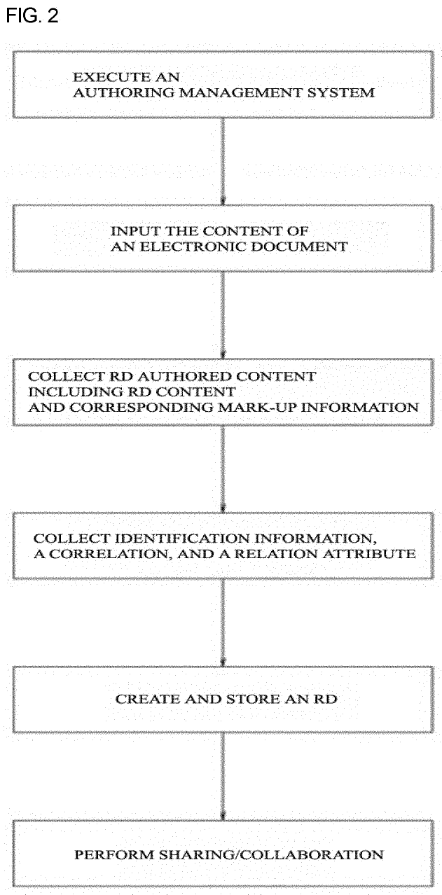

FIG. 1 is a diagram illustrating the functional concept of an authoring management system in the form of systematic blocks as a preferred example according to the present invention, and FIG. 2 is a flowchart illustrating a process in which an authoring management system creates an RD and converts the generated RD into data in order to enable sharing and collaboration over a network as a preferred example according to the present invention.

Referring to FIGS. 1 and 2, the authoring management system is constructed in a communication environment in which a client terminal and a server are connected over a network.

The author executes the authoring management system in the client terminal, and creates the content of an electronic document by entering input information, etc. in an application of the authoring management system installed in the client terminal.

In the process of authoring an electronic document, an author designates a section of RD content for the generation of an RD in the content. When the section of RD content is designated, the RD content located in the section and corresponding mark-up information are checked and classified as RD authored content. Meanwhile, when the RD authored content is classified, identification information is allocated such that it can be distinguished from other undesignated content in the content of the electronic document.

When the RD authored content is classified and identification information is allocated, the authoring management system collects a correlation and relation attribute regarding a specific RD by inquiring them of the author. The process in which the authoring management system collects a correlation and a relation attribute will be described with reference to an example.

When the RD authored content, the identification information, the correlation and relation attribute are identified, the authoring management system creates an RD by converting the information into a dataset, and performs conversion into data for the purposes of systematic management of the RD together with other RDs, network sharing, and collaboration. In general, data is stored and managed in a DB in the Unicode Transformation Format (hereinafter ‘UTF’) format, so that the RD in this embodiment is also stored and managed in the DB in UTF data format. However, in addition to the encoding method using the UTF format for DB storage, an encoding method using the ASCII (American Standard Code for Information Interchange) format may be applied.

Meanwhile, the RD authored content may be converted into data with the RD content and the corresponding mark-up information separated from each other. In the loading of the RD authored content, the RD content may be output in the format of the corresponding mark-up information, or may be output in the basic format without applying the format of the mark-up information. When the RD content and corresponding mark-up information of the RD authored content are separated from each other, the identification information, correlation, and relation attribute of the corresponding RD are stored and managed in the state of being directly linked with the RD content or the corresponding mark-up information.

When the RD and the electronic document are converted into data, the authoring management system constructs a sharing environment in which users can access the RD and a collaborative environment in which the RD can be edited, and users share the RD and collaborate on the RD in these environments.

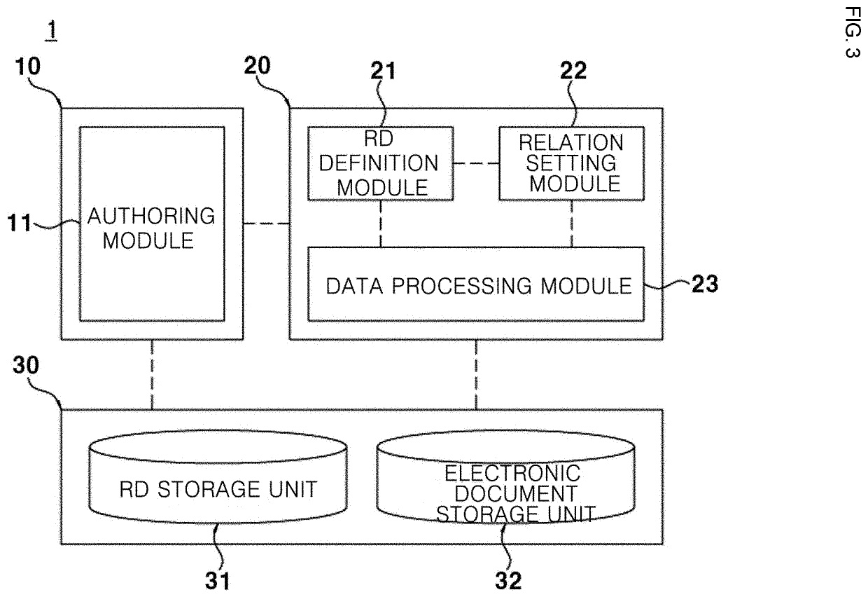

FIG. 3 is a block diagram schematically showing an authoring management system as one preferred example according to the present invention.

Referring to FIG. 1 to 3, as one preferred embodiment according to the present invention, an authoring management system 1 includes an electronic document authoring unit 10, an RD generation unit 20, and a storage unit 30 operating on the operating system (OS) of a computer system.

The electronic document authoring unit 10 includes an authoring module 11 for the generation and processing of various types of content (which is used to distinguish it from ‘RD authored content’ used as an RD element according to the present invention for ease of description), e.g., text, an image, a table, a video, a graph and/or the like, input by an author (or a user) via an input device such as a keyboard, a mouse or the like. In this case, the authoring module 11 is intended to operate as a general word processor. A detailed description of the authoring module 11 will be omitted because well-known word processing technologies may be applied to the creation, storage, etc. of content based on input via a keyboard, a mouse or the like. However, in the authoring management system 1 according to the present invention, the authoring module 11 is different from well-known conventional technologies, and this will be described later in terms of the designation of an RD marker or the generation and display of an RD setting key in the generation or collection of RD authored content for the construction of an RD.

The RD generation unit 20 operates in conjunction with the electronic document authoring unit 10, and includes an RD definition module 21, a relation setting module 22, and a data processing module 23.

When RD authored content is designated by an RD marker and an RD setting key to be described later, the RD definition module 21 classifies the RD authored content as an RD element by separating the RD authored content from other RD authored content and collects identification information, and the relation setting module 22 collects the correlation of the RD authored content and a relation attribute with a target RD. Furthermore, the data processing module 23 generates an RD by using the collected RD authored content, the identification information, the correlation and the relation attribute as a dataset, and stores the RD in an RD storage unit 31.

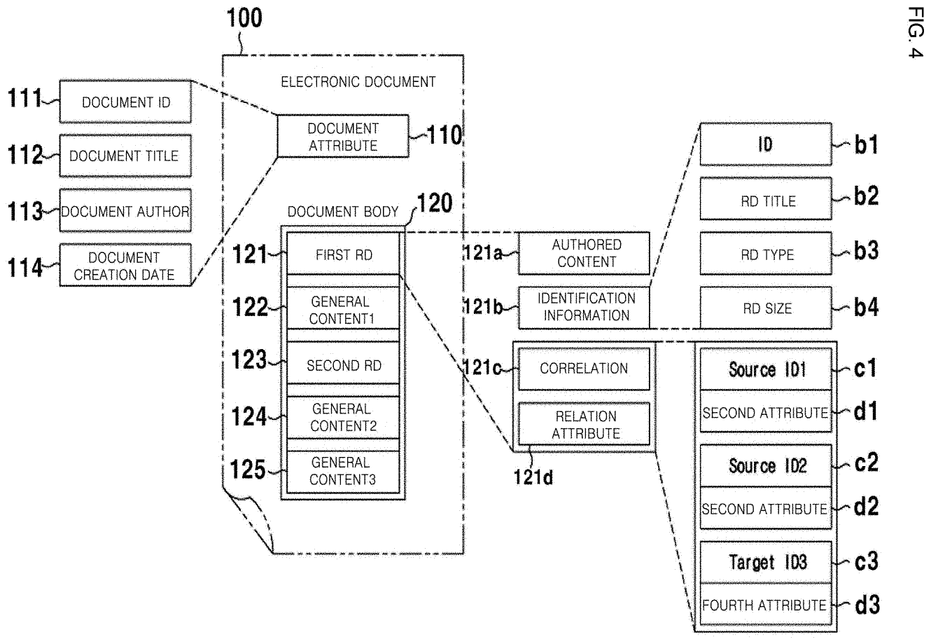

FIG. 4 is a block diagram showing the data structure of an electronic document generated by an authoring management system as one embodiment according to the present invention.

Referring to FIGS. 3 and 4, as one example of the generated authoring management system 1 according to the present invention, an electronic document 100 is divided into a document attribute 110 and a document body 120.

The document attribute 110 is the meta information of the electronic document 100, and includes a document ID 111, a document title 112, a document author 113, and a document creation date 114. The document attribute is generated by the authoring module 11 and stored in the electronic document storage unit 32 by the data processing module 23.

The document body 120 includes content constituting the content of a document created by the author, is generated by the authoring module 11, and is stored in the electronic document storage unit 32 by the data processing module 23. The content is divided into authored content 121a designated and managed as an RD and general content 122. In this case, the general content refers to general content 122, 124 and 125, excluding the authored content 121a designated and managed as an RD, in the document body. The illustrated example is an example in which two RDs are generated in the electronic document 100.

The RD includes the authored content 121a, identification information 121b, a correlation 121c, and a relation attribute 121d.

The authored content 121a is content C1 designated as an RD.

The identification information 121b is the information that enables the authored content to be distinguished from other authored content and then managed, and has an ID b1 having a unique identification value. The ID b1 is the information that enables the RD to be distinguished from other RDs and defined as an independent object, and may be allocated based on the creation time of the authored content D1. Furthermore, the ID b1 may be used by combining the creation time of the authored content 121a, a computer ID, and the document ID 111 for convenience of the author or search.

The correlation 121c includes source IDs c1 and c2 and a target ID c3 as information indicating whether or not there is a connection between pieces of authored content 121a. The target ID c3 refers to an ID in the identification information 121b of the target RD. The source IDs c1 and c2 are the identification information 121b of the source RDs designated by other RDs (hereinafter, an RD designated as having the correlation 121c with the original RD is referred to as the ‘source RD’ for ease of description) as having the correlation 121c. In this case, the ID b1, the source IDs c1 and c2, and the target ID c3 are the values allocated from the viewpoint of the original RD, and needs to be understood as being based on relative concepts that vary depending on designating or being designated. The source RD and the target RD need to be designated based on the directionality of the correlation 121c, which is a major factor that determines the relation attribute 121d.

The relation attribute 121d refers to the characteristic of a change between the authored content 121a having the correlation 121c, and the range, scope or definition thereof may be defined in various manners. Since this relation attribute 121d may be defined in various manners, it may not be determined uniquely. However, for convenience of understanding, four relation attributes 121d are illustrated. For example, a first attribute may be defined as ‘identification’ in the case where the pieces of authored content 121a of RDs are identical with each other, a second attribute may be defined as ‘concretization’ in the case where an addition is made to the authored content 121a of an RD having the correlation 121c, a third attribute may be defined as ‘partialization’ in the case where a target is part of the authored content 121a of an RD having the correlation 121c, and a fourth attribute may be defined as ‘progression’ in the case where a change and an addition are made to the authored content 121a of an RD having the correlation 121c.

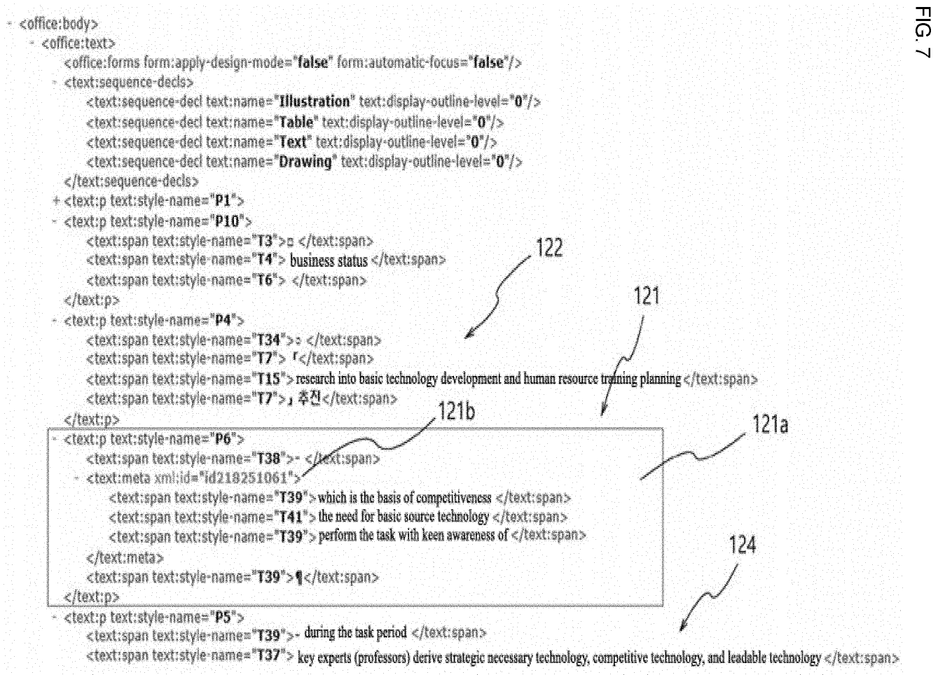

As an example shown in FIG. 7, the electronic document 100 has two RDs 121 and 123. The first RD 121 has the relations 121c with three RDs, and has respective relation attributes accordingly. In this case, the second RD 123 may have various correlations and relation attributes depending on designating or being designated in a data structure illustrated as the first RD 121. In the illustrated example, the two RDs 121 and 123 are presented, but the number of RDs may be increased or decreased in various manners according to RD designation. Furthermore, for the convenience of explanation and understanding, the correlations 121c and relation attributes 121d of the first RD 121 will be described using the four attributes (‘first attribute’: ‘identification,’ ‘second attribute’: ‘concretization,’ ‘third attribute’: ‘partialization,’ and ‘fourth attribute’: ‘progression’) as an example.

The first RD 121 is an original RD having the ID b1. The first RD has the correlation 121c with the source ID1 c1 and the source ID2 c2, and has second attributes d1 and d2. This is an example in which the authored content 121a of the first RD 121 is concretized from the authored content of source ID1 c1 and designated as the second attribute d1, and is also an example in which the authored content 121a of the first RD 121 is concretized from the authored content of source ID2 c2 and designated as the second attribute d2. In addition, the first RD 121 has the correlation 121c with the target ID3 c3, and has a fourth attribute d3. This is an example in which the authored content 121a of the first RD 121 is progressed by content change and addition, has the relation 121c with the target ID3 c3, and is designated as the fourth attribute d3.

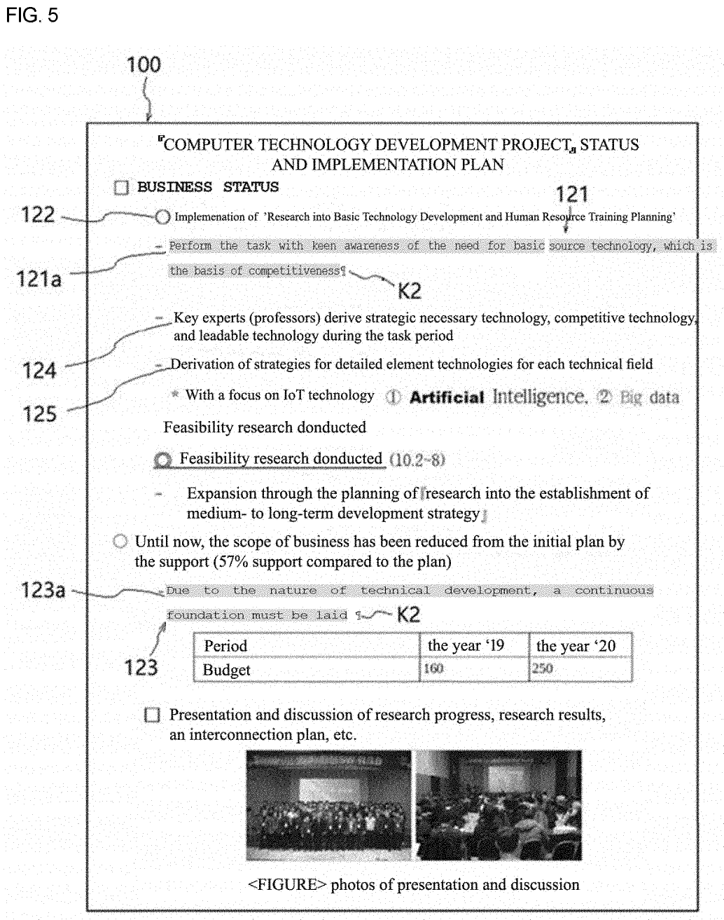

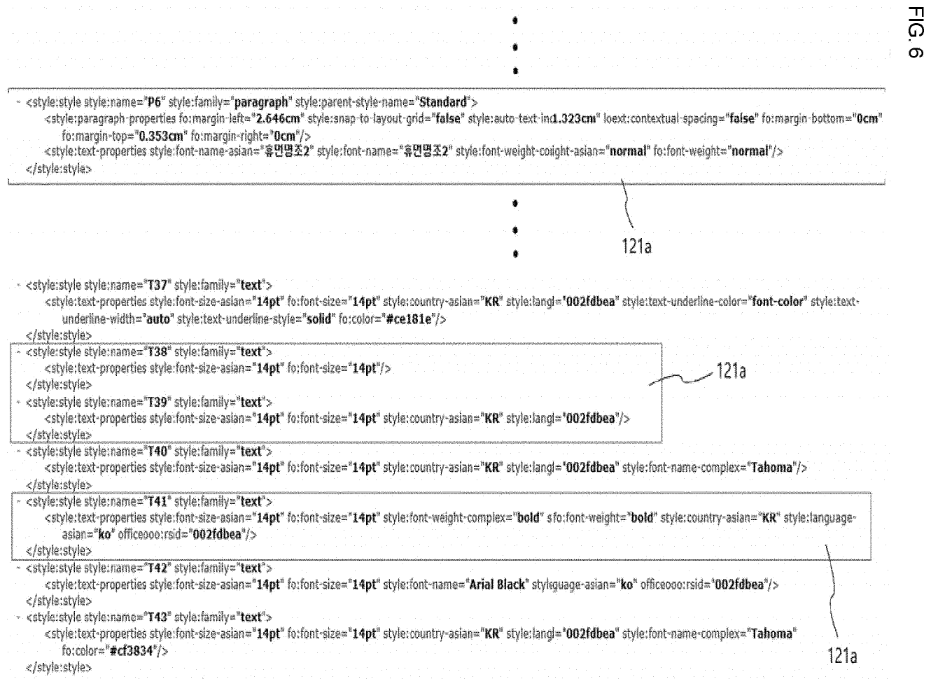

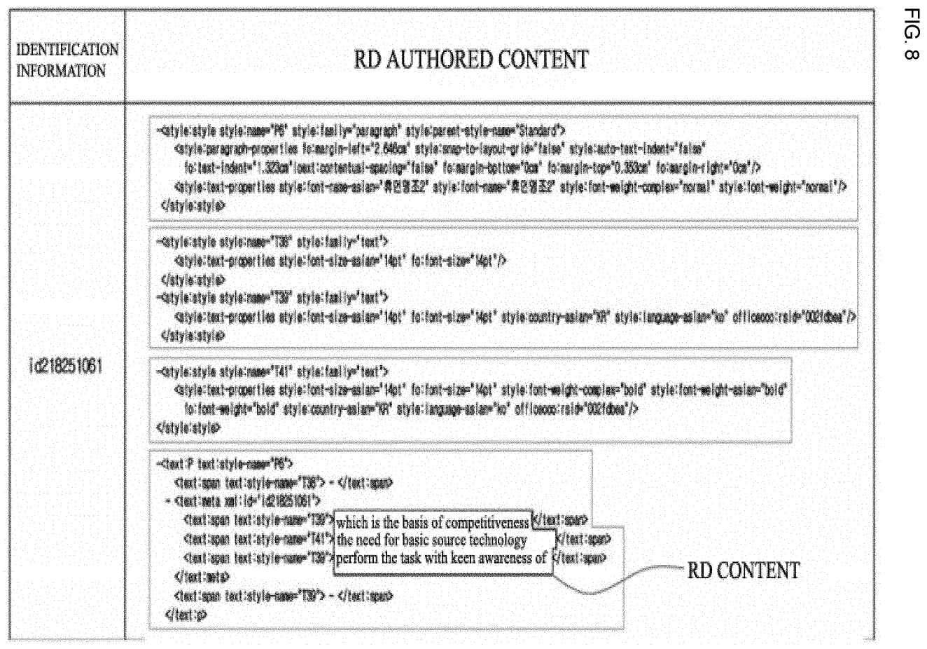

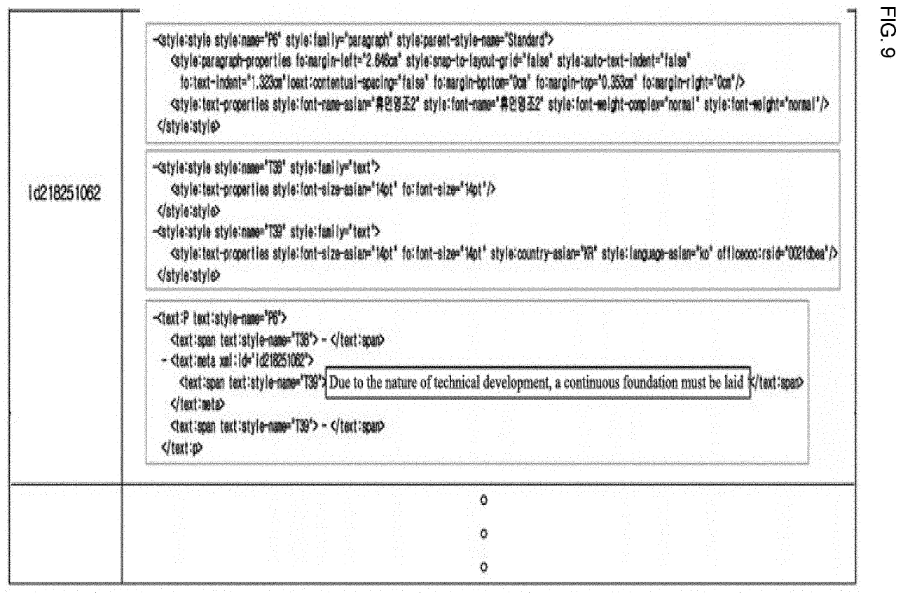

FIG. 5 shows an image of the content of an electronic document including an RD generated by an authoring management system as an example according to the present invention, FIGS. 6 and 7 show source code for the RD authored content of the electronic document shown in FIG. 5 as an example according to the present invention, and FIGS. 8 and 9 show tables showing the RD authored content extracted from the source code of FIGS. 6 and 7 on a per-identification information basis as an example according to the present invention.

Referring to FIGS. 2 to 9, an author may authore the electronic document 100 having various types of content as shown in FIG. 5 through the authoring unit 10 having an editor function configured in the authoring management system, and may diversify output styles for respective types of content. In greater detail, at the top of the electronic document 100, content is shown in text as ‘ [symbol] COMPUTER TECHNOLOGY DEVELOPMENT PROJECT [symbol] STATUS AND IMPLEMENTATION PLAN,’ the format of the text is set such that the font is ‘headline,’ the font size is ‘19,’ and the font color is ‘black.’ In addition, the special symbols “ [symbol] ” and “ [symbol] ” are inserted in front of and behind ‘COMPUTER TECHNOLOGY DEVELOPMENT PROJECT,’ respectively. As a result, a corresponding part includes RD content in a text format expressed as ‘ [symbol] COMPUTER TECHNOLOGY DEVELOPMENT PROJECT [symbol] STATUS AND IMPLEMENTATION PLAN’ and mark-up information defining the text format. The authoring module 11 defines the output format of the corresponding content with the corresponding mark-up information like a normal word processor, and expresses it as a source code, as shown in FIG. 6.

Meanwhile, in the process of authoring the content of the electronic document 100 via the authoring unit 10 of the authoring management system, the RD definition module 21 designates RD content according to the input information of the author, checks the corresponding mark-up information of the RD content, and classifies pieces of RD authored content 121a and 123a. RDs 121 and 123 are defined based on the classified pieces of RD content 121a and 123a. Furthermore, an RD setting key K2 is inserted behind each of the pieces of RD authored content 121a and 123a in order to visually distinguish it from pieces of general content 122, 124, and 125. Since the RD setting key K2 is a kind of symbol for visualization, the shape and presentation method of the RD setting key K2 may be modified in various manners.

Once the pieces of RD authored content 121a and 123a of the RDs 121 and 123 have been defined thereafter, the RD definition module 21 allocates identification information for the distinction between the RDs, which is configured on the mark-up information of the corresponding RD authored content 121a and 123a. In the mark-up information of the present embodiment, the identification information 121b of the RD authored content 121a is <text:meta×mark-up information:id=“id218251061”>. The authoring management system identifies the corresponding RD 121 from the other RD 123 based on the identification information 121b of the corresponding RD 121, and systematically stores and manages data on a per-RD (121 or 123) basis even after conversion into the data.

When the RD content of the RD authored content 121a and 123a is designated in the content configured in the electronic document 100, the relation setting module 22 collects the correlations and relation attributes of the RDs 121 and 123 by inquiring them of the author. A more detailed description of an inquiry about a correlation and a relation attribute will be described based on an example below.

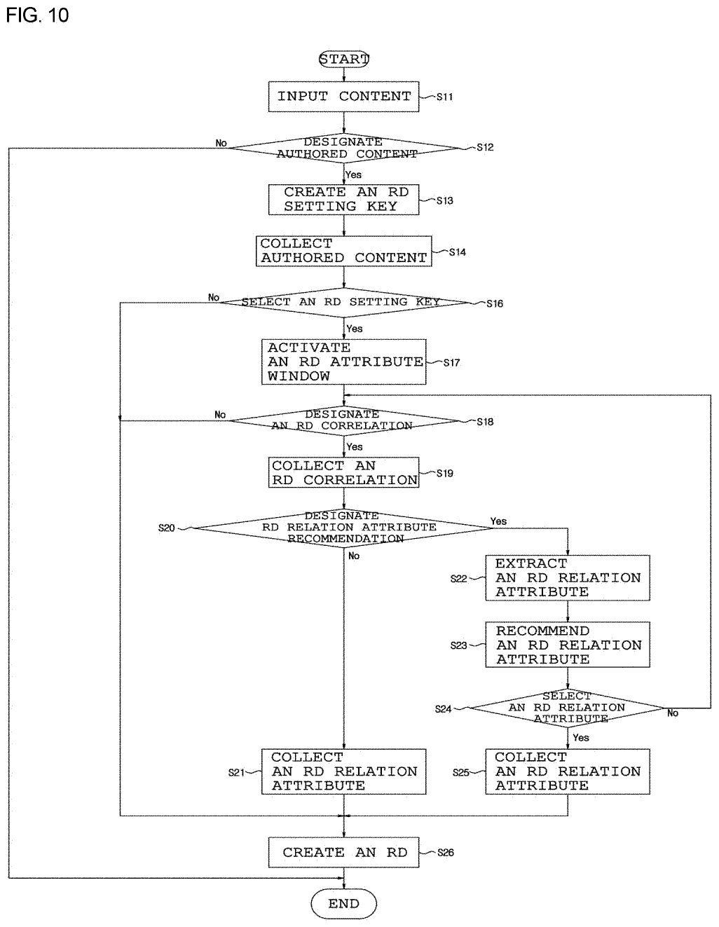

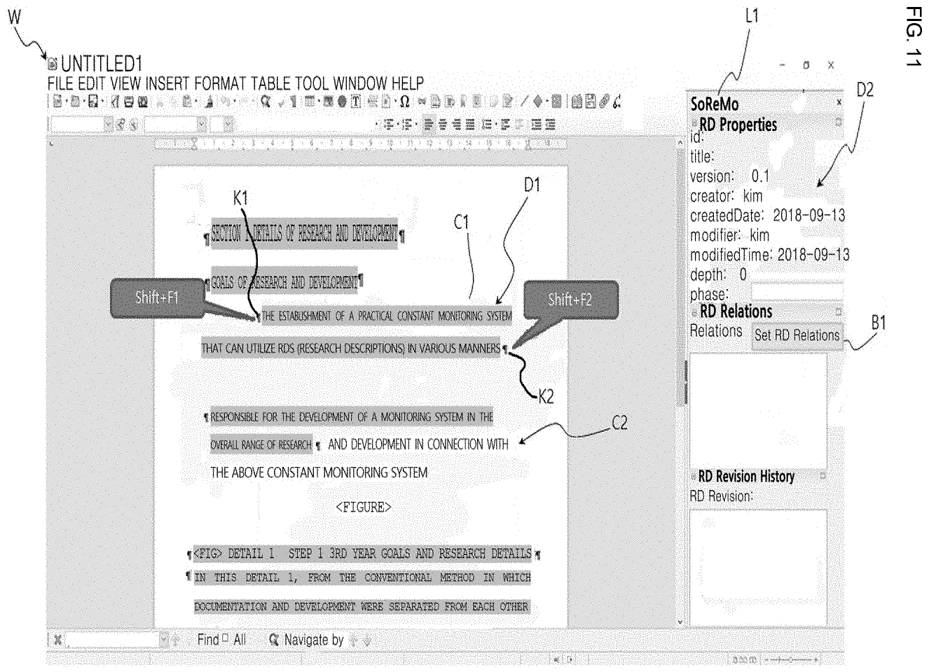

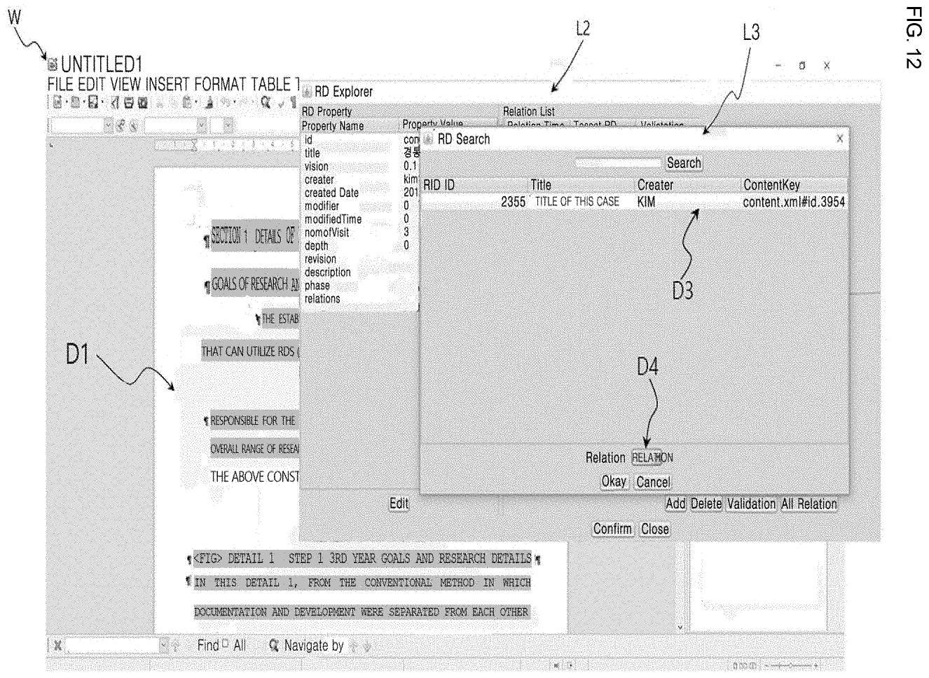

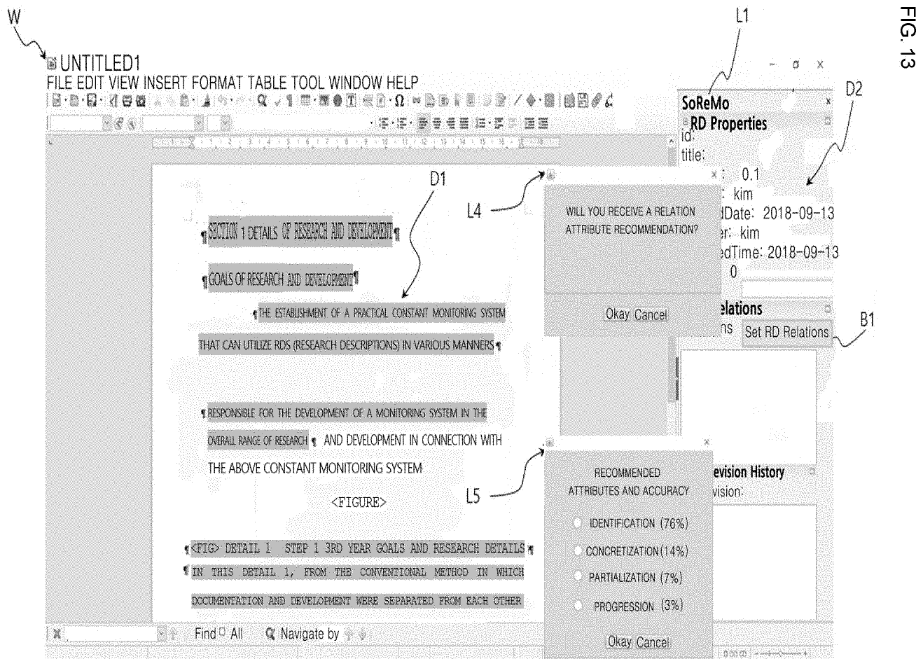

FIG. 10 is a flowchart showing a process in which an RD is generated on an electronic document as one preferred example according to the present invention, FIG. 11 shows an electronic document task window in which an RD setting key is generated as one example according to the present invention, FIG. 12 shows an electronic document task window in which a correlation collection window and a relation attribute collection window are popped up as one example according to the present invention, and FIG. 13 shows an electronic document task window in which a query window for querying whether or not to recommend a relation attribute and a relation attribute recommendation window are generated as one example according to the present invention.

Referring to FIGS. 3 to 13, an author creates content C1 using an input device such as a keyboard or a mouse at step S11. When the author desires to designate the content C1 being created as the RD authored content D1 of an RD according to the present invention at step S12, an RD marker q is marked at the start point of the content C1 and an RD setting key is generated at the end point of the content C1 at step S13. The RD marker and the RD setting key may be generated in various manners. As an example, the RD marker and the RD setting key may be generated and marked using values corresponding to the input of a keyboard or the input of a mouse. For example, when the input of the keyboard is utilized, the RD marker marks the starting point using shift+F1 and the RD setting key generates a setting key at the end point using shift+F2. When the input of the mouse is utilized, the RD marker is marked by clicking the start point and the RD setting key is generated by clicking the end point.

When the RD marker and the RD setting key are input, the authoring module 11 allocates identification information D2 to the content C1 located between the RD marker K1 and the RD setting key K2 and collects RD authored content D1 by classifying the content C1 as the RD authored content D1 at step S14. In this case, the identification information D2 is used to define the RD authored content D1 as an independent object, and may be constructed in various manners on the basis of convenience in the field of the present invention. As an example, an unique independent object may be obtained by allocating the time values, at which RD authored content is generated, to the identification information D2 using the RD marker and the RD setting key. Alternatively, the identification information D2 may be obtained by a combination of the ID of a computer or the document name of an electronic document for the convenience of an author or search. The example shown in FIG. 11 is one example in which the RD authored content D1 is displayed in a state in which the RD authored content D1 is inverted to be distinguished from the general content C2 by the block designation of the start and end points of the RD authored content D1.

In this case, the RD authored content D1 designated by the author displays the identification information D2 of the RD authored content D1 on an RD attribute window L1 through the activation of the RD attribute window L1 at step S17. In this case, the RD attribute window L1 provides an interface B1 for the input of a correlation and a relation attribute to the author. For this purpose, the relation setting module 22 includes a correlation input unit (not shown) and a relation attribute input unit (not shown). Referring to FIG. 12, the correlation input unit functions as a correlation collection window L2, and allows the author's own RD or another RD of another person to be designated. Furthermore, the relation attribute input unit functions as a relation attribute collection window L3, and allows a relation attribute, associated with the target RD, to be designated.

When an RD (hereinafter the RD designated as having a correlation with the RD authored content D1 currently being worked on is referred to as the ‘target RD’ to be distinguished from other RDs for ease of description) is input to the correlation collection window L2 at step S18, the relation setting module 22 collects information as a correlation D3 with the target RD having a correlation with the RD authored content D1 currently being worked on at step S19. Meanwhile, when the target RD is not input, the relation setting module 22 defines the correlation and relation attribute of an undetermined null attribute, and the data processing module 23 generates the correlation and relation attribute of the null attribute, the RD authored content D1 and the identification information D2 as an RD (hereinafter an RD associated with the RD authored content currently being worked on is referred to as the ‘original RD’ to be distinguished from other RDs for ease of description) and stores the RD in the RD storage unit 31.

When a relation attribute D4 is input to the correlation collection window L2 and the relation attribute collection window L3, the relation setting module 22 collects relation attribute D4 information about the correlation D3 (a source and a target) between the original RD and the target RD at step S21. Furthermore, the data processing module 23 generates an original RD having the RD authored content D1, the identification information D2, the correlation D3 and the relation attribute D4 as a single dataset and stores the original RD in the RD storage unit 31 at step S26.

Meanwhile, as shown in FIG. 13, when the correlation D3 is input to the correlation collection window L2 but a relation attribute is not input to the relation attribute collection window L3, the data processing module 23 queries whether or not to recommend a relation attribute via the query window L4 at step S20. When the author selects recommendation in the query window L4, the relation attribute recommendation unit of the relation setting module 22 retrieves the existing target RD information stored in the RD storage unit 30 at step S22, predicts a relation attribute between the RD authored content of the target RD and the RD authored content D1 of the original RD by analyzing the RD authored content of the target RD and the RD authored content D1 of the original RD in association with each other, and recommends the relation attribute between the original RD and the target RD by outputting the results of the prediction to the relation attribute recommendation window L5 at step S23. The relation attribute recommendation unit supports the determination of a relation attribute appropriate for RD authored content being worked on, and the author may efficiently and easily determine a relation attribute between the original RD and the target RD by reviewing the relation attributes suggested in the relation attribute recommendation window L5.

When the author reviews the relation attributes suggested by the relation attribute recommendation unit and then enters a relation attribute to the relation attribute entry window L3, the relation setting module 22 collects information using the relation attribute D4 between the original RD and the target RD at step S25. Furthermore, the data processing module 23 generates an original RD having the RD authored content, the identification information, the correlation and the relation attribute as a single dataset and stores the original RD in the RD storage unit 31 at step S26. Furthermore, when relation attributes are suggested by the relation attribute recommendation unit but the author does not enter a relation attribute, the relation setting module 22 deletes previously collected RD correlations through resetting and repeats the process from the RD correlation designation step S18.

For reference, the relation attribute recommendation unit analyzes the RD authored content of the original RD and the RD authored content of the target RD having a correlation with the original RD, searches for optimum relation attributes, and displays the results of the search together with numerical accuracies in the relation attribute recommendation window L5. For the analysis of the RD authored content of the RDs and the recommendation of the relation attributes, a widely used deep learning algorithm such as a Convolutional Neural Network (CNN) model may be utilized.

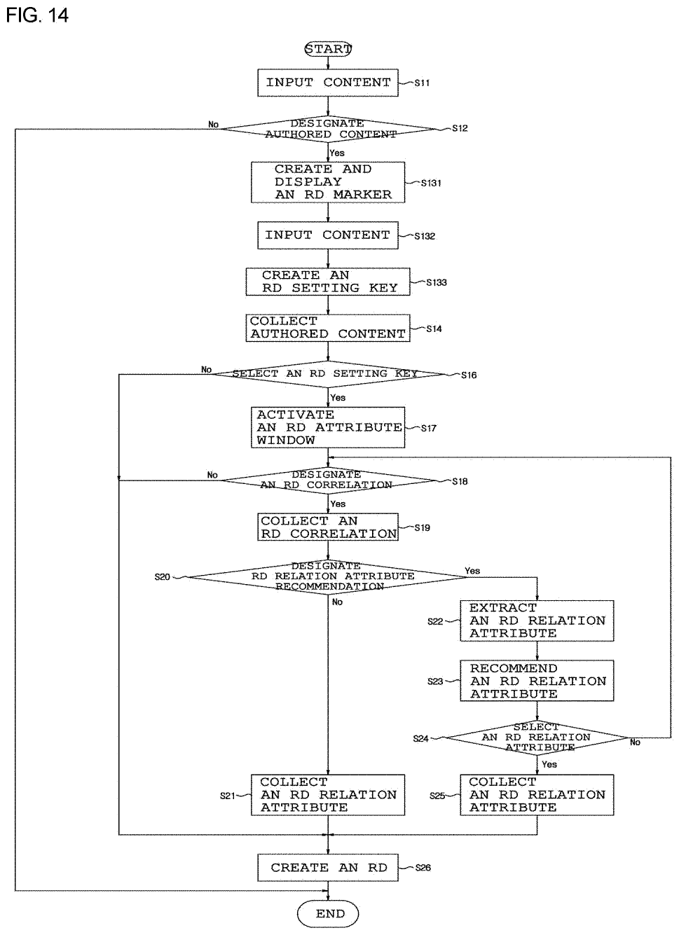

As described with reference to FIGS. 3 to 13, the author may allow an RD according to the present invention to be generated for a document, a paragraph, a sentence, or a phrase or word after the document has been created. By the way, it may be convenient for the creation and management of a document for the author to allow an RD to be generated at the same time as a document is created. This will be described with reference to FIG. 14.

FIG. 14 is a flowchart showing a process in which an RD is generated as content is created as another example according to the present invention. In this case, the reference numerals that are the same as those described and illustrated with reference to FIG. 10 denote the same steps having the same results.

Referring to FIGS. 10 and 14, as the other example according to the present invention, the process of generating an RD is the same as the step of generating an RD described and illustrated with reference to FIG. 10, but they are different only in the collection of stored content according to the display of an RD marker, the input of content, and the generation of an RD setting key.

First, when the content to be input is intended to be an original RD, the author designates a location by entering an RD marker K1 (see FIG. 11) via an input device before inputting the content at step S131. When content is created after the entry of the marker K1 at step S132 and an RD setting key K2 (see FIG. 11) is generated via the input device at step S133, the authoring module 11 allocates identification information D2 (see FIG. 3) to content located between the RD marker K1 and the RD setting key K2 and collects it by classifying it as RD authored content D1 (see FIG. 3) at step S14. Furthermore, a subsequent process generates and stores an RD at the same steps as described and illustrated with reference to FIGS. 11 to 13, and a detailed description thereof will be omitted to avoid redundant description.

As described above, the RD according to the present invention may be generated subsequently, but may be generated at a work generation step. Accordingly, it is easy to determine the flow of changes in the RD authored content because the connection between the thoughts of an author may be reflected and expressed in the RD authored content as it is, it may be also managed as knowledge data in the relevant field, and a benefit is achieved in that there may be implemented a management system in which the authoring and management of electronic documents and RD authored content are always associated with each other.

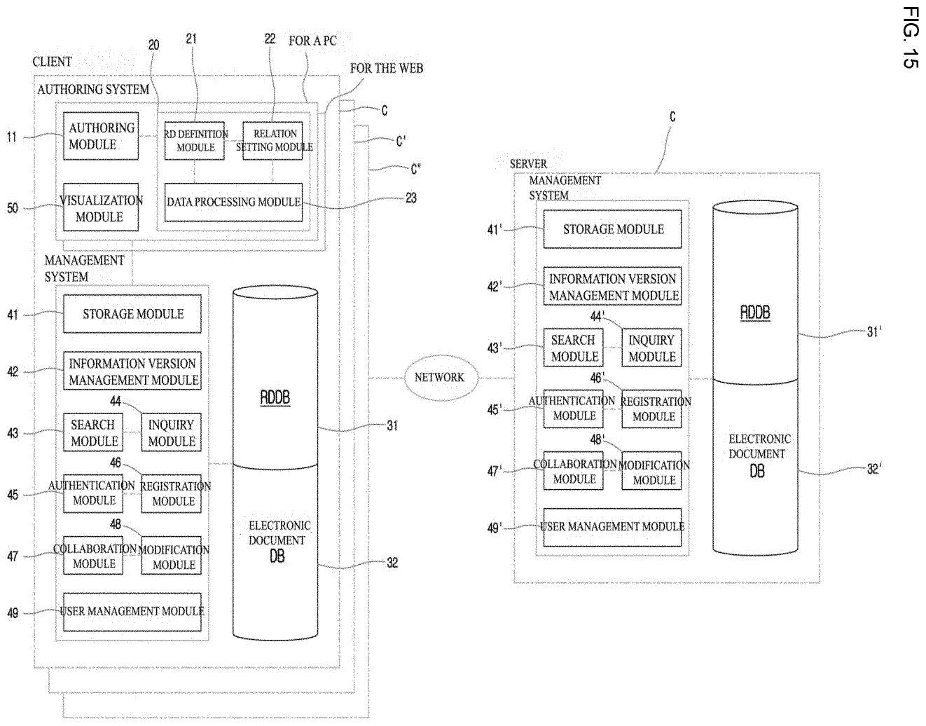

Referring to FIG. 15, the authoring management system (or a ‘server-client system’) according to the present invention constitutes a relation server (S) network system along with author clients C, C′, and C″ (hereinafter ‘C’). In this case, the author clients C and the relation server S perform data communication using a TCP/IP-based HTTP protocol, and a data format may be based on a JSON (JavaScript Object Notation) method.

While communicating data with the one or more author clients C, the relation server S manages RDs of the author clients C in the form of a dataset, and relays and manages dataset exchange between the author clients C. Accordingly, a management system between the RDs is not limited to the range of the author clients C, and may collect, exchange, and efficiently manage RD information by expanding to an Ethernet as well as a global network such as the Internet.

Each of the author clients C of the authoring management system according to the present invention includes the authoring system including the authoring unit 10 (see FIG. 3) and the RD generation unit 20 (see FIG. 3), the management system, and the storage unit 30. Since the authoring unit 10, RD generation unit 20, and storage unit 30 of the authoring system have been described above, descriptions thereof will be omitted.

The management system includes: a storage module 41 configured to store an RD and electronic document data generated by the authoring system in the storage unit 30 according to the settings of the data processing module 23; an information version management module 42 configured to systematically manage systematic connectivity between RDs; a search module 43 configured to search RDs and electronic documents in the storage unit 30 according to a search command of the authoring system; an inquiry module 44 configured to inquire the search conditions of the search module 43 of a user in order to collect the search conditions and transmit the collected search conditions to the search module 43; an authentication module 45 configured to process an authentication procedure for a user when the authoring system and the management system are executed; a registration module 46 configured to register user information for user authentication; a collaboration module 47 configured to perform processing in order to allow the user of the author client C connected to the relation server S to collaborate on an electronic document and RD authoring; a modification module 48 configured to update, store, and manage modification histories of the electronic document and the RD created through collaboration; and a user management module 49 configured to receive, store, and manage the user information registered by the registration module 46.

Meanwhile, the relation server S may configure the management system of the author client C in the same manner, and further includes a member management module 49′. Since a number of users access the relation server S, and perform user registrations and authentication procedures, the member management module 49′ stores and manages authentication procedures and registered user information.

As described above, the relation server S performs processing in order to allow a number of users to share and collaborate on RDs, searches for a target RD to be associated with in the author client C for RD generation, transmits it to the author client C, and stores the RD generated by the author client C in the RDDB 31′ of the relation server S.

For reference, the RD search of the search modules 43 and 43′ configured in the author client C and the relation server S may be performed in various manners by using the RD authored content, identification information, correlation, and relation attribute of an RD as search conditions. Furthermore, the search modules 43 and 43′ allow the visualization modules 50 of the author clients C to search for a plurality of RDs associated with each other and multi-dimensionally visualize the structure of association between the retrieved numerous RDs.

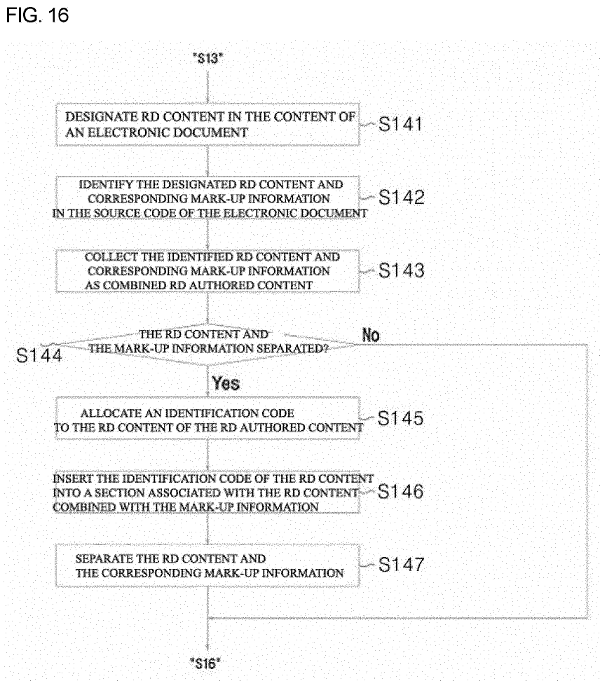

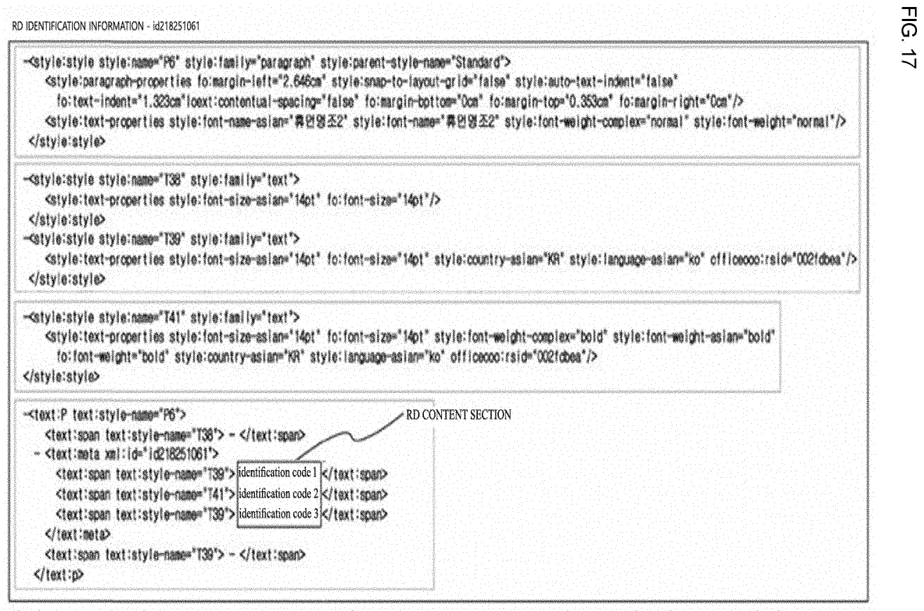

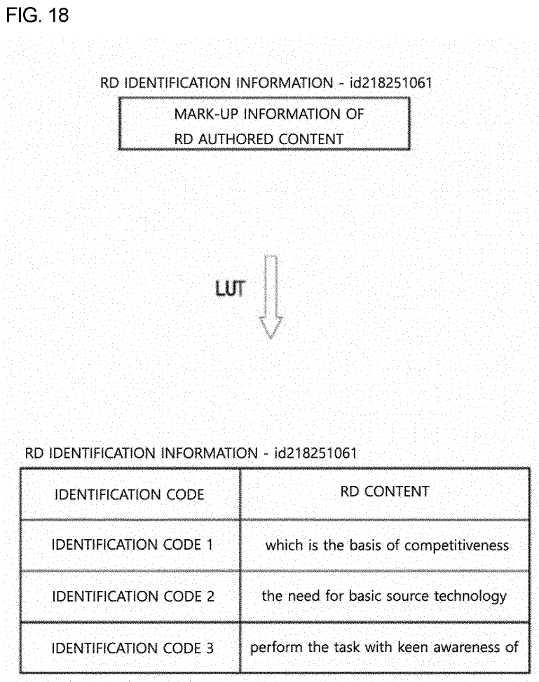

FIG. 16 is a flowchart showing a process in which RD authored content is collected as a preferred example according to the present invention, and FIGS. 17 and 18 show tables showing the configurations of the RD content and corresponding mark-up information of RD authored content for the authoring management system to convert an RD into data as an example according to the present invention.

Referring to FIGS. 5 to 8, 9, 15 to 17, and 18, the authoring module 11 designates RD content in the content of an electronic document in response to an input key of an author at step S141. The RD definition module 21 identifies the corresponding mark-up information of the designated RD content from the source code of the electronic document at step S142, and collects the identified RD content and corresponding mark-up information as RD authored content at step S143.

The RD definition module 21 may separate and execute or combine and execute the RD content and the corresponding mark-up information according to a set procedure. In the present embodiment, a method of separating and executing RD content and corresponding mark-up information will be described first. When the RD content and the corresponding mark-up information are collected as described above, the RD definition module 21 allocates the identification code of the RD content at step S145.

As shown in FIG. 17, the pieces of RD content of the RD authored content to which the identification information is allocated as ‘id218251061’ are three pieces of content, i.e., ‘which is the basis of competitiveness,’ ‘the need for basic source technology,’ and ‘performs the task with keen awareness of.’ The RD definition module 21 allocates ‘identification code 1,’ ‘identification code 2,’ and ‘identification code 3’ to the respective pieces of RD content.

When an identification code is allocated to the RD content, the RD definition module 21 inserts the identification code into the mark-up information of the RD content at step S146. The location where the identification code is inserted may be a section in which the RD content is located as in the present embodiment, or may be a plurality of sections in which pieces of corresponding mark-up information associated with corresponding RD content are located in a source code.

When the identification code of the RD content is inserted into the mark-up information, the RD content combined with the mark-up information is separated and managed individually, as shown in FIG. 15, at step S147.

Meanwhile, the RD authored content may be stored and managed with the RD content and the corresponding mark-up information combined with each other without the separation thereof. Accordingly, the RD definition module 21 manages the RD content and the corresponding mark-up information without separate processing when the RD authored content constituting the RD content and the corresponding mark-up information is collected.

The table shown in FIG. 18 is represented in a look-up table (LUT) format in order to help a visual understanding of a method of storing the RD content 121a and 123a.

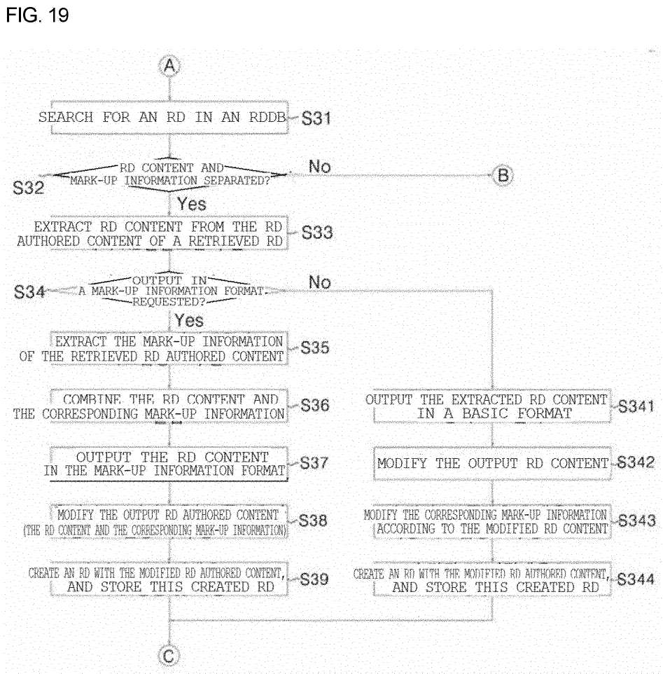

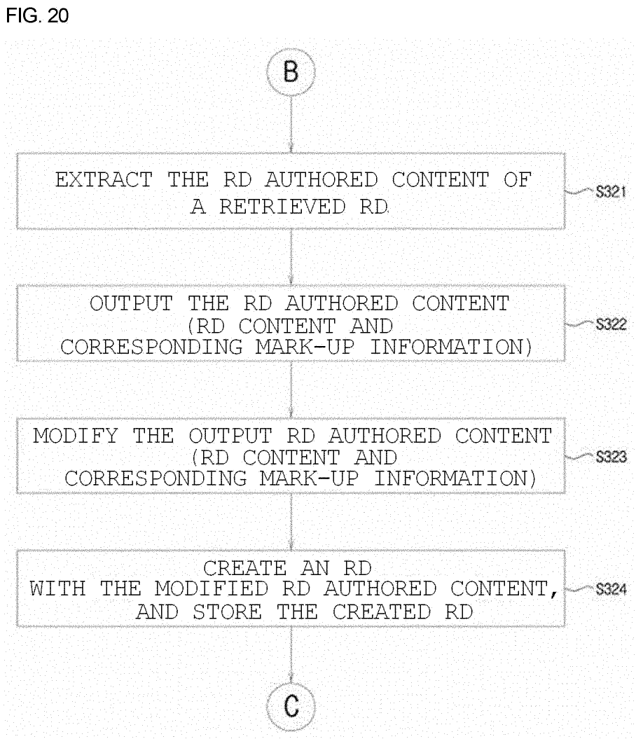

FIG. 19 is a flowchart illustrating a process in which a user searches for an RD stored in an RDDB for the purpose of sharing and collaboration in an authoring management system as an example according to the present invention, and FIG. 20 is a flowchart illustrating another implementation process in which a user searches for an RD stored in an RDDB for the purpose of sharing and collaboration in an authoring management system as an example according to the present invention.

FIGS. 5 to 8, 9, and 15 to 20, the user searches for an RD stored in the RDDB 31′ of the relation server for the purpose of sharing or collaboration at step S31. The RD search is performed by the search module 43′ in the RDDB 31′ according to the search conditions collected by the inquiry module 44′.

As described above, in the format of the RD authored content stored in the RDDB 31′, the RD content and the corresponding mark-up information may be separated from or combined with each other, and a subsequent procedure is performed differently accordingly at step S32.

When the RD content and the corresponding mark-up information are separated and then stored, the search module 43′ first extracts the RD content in order to search the RD authored content at step S33. Since the RD content is associated with the identification information of the corresponding RD, the search module 43′ may extract the RD content based on the identification information of the RD itself.

The search module 43′ inquires whether to perform output in the mark-up format of the inquiry modules 44 and 44′ so that the user can check and select it at step S34. When the user agrees to the output in the mark-up format, the mark-up information is extracted from the retrieved RD content at step S35.

When the mark-up information of the RD authored content is extracted, the corresponding RD content is combined with the corresponding mark-up information based on the identification code inserted into the mark-up information at step S36, and the RD content is output in the format of the mark-up information through the client terminal of the user at step S37. The RD content is output through an output means of a word processor function, such as the authoring module 11.

When the RD authored content is output, the user may edit the output RD authored content or change the style thereof by using the functions of the output means at step S38, and the RD content and the corresponding mark-up information are modified in response to the editing or change of the style. As for a general output means, when RD content and mark-up information are changed according to the operation of a user, the corresponding mark-up information of the RD content is modified according to the change.

When the user modifies the RD content and the corresponding mark-up information and uploads the corresponding RD authored content to the management system, the modification module 48′ of the management system separates the RD content and corresponding mark-up information of the RD authored content, generates an RD with the modified RD authored content, and stores it in the RDDB 31′ at step S39.

Meanwhile, when as a result of the inquiry about whether to output the RD content in the mark-up information format at step S34, the user does not agree to the output in the mark-up information format, only the extracted RD content is output to the client terminal of the user at step S341. A general word processor window for the execution and output of content has a mark-up format set by default, so that even when only RD content without mark-up information is transmitted, the mark-up information of the basic format is applied to the RD content and then the RD content is output.

When the RD authored content is output, the user edits the output RD authored content in the basic format at step S342. The mark-up information in the basic format is applied to the modified RD content part, so that when the user edits the RD content, the corresponding mark-up information of the existing RD content is also modified in connection with this at step S343.

When the RD content and the corresponding mark-up information are modified, an RD is generated with the modified RD authored content and then stored in the RDDB 31′ at step S44.

Meanwhile, as shown in FIG. 19, when the RD content and corresponding mark-up information of the RD authored content are stored in the RDDB 31′ in a combined state, the search module 43′ extracts the RD authored content of the retrieved RD at step S321 and outputs the RD authored content in which the RD content and the corresponding mark-up information are combined at step S322, as shown in FIG. 20. The output RD content is output through the authoring module 11 or the output means in the format of the corresponding mark-up information at step S322.

The RD authored content output to the authoring module 11 or the output means is processed and edited according to the input key of the user, or the RD content and the corresponding mark-up information are modified in response to the change of the style at step S323.

When the RD content in which the modified RD content and the corresponding mark-up information are combined is uploaded to the management system, the modification module 48′ of the management system generates an RD corresponding to the modified RD authored content and stores it in the RDDB 31′ at step S324.

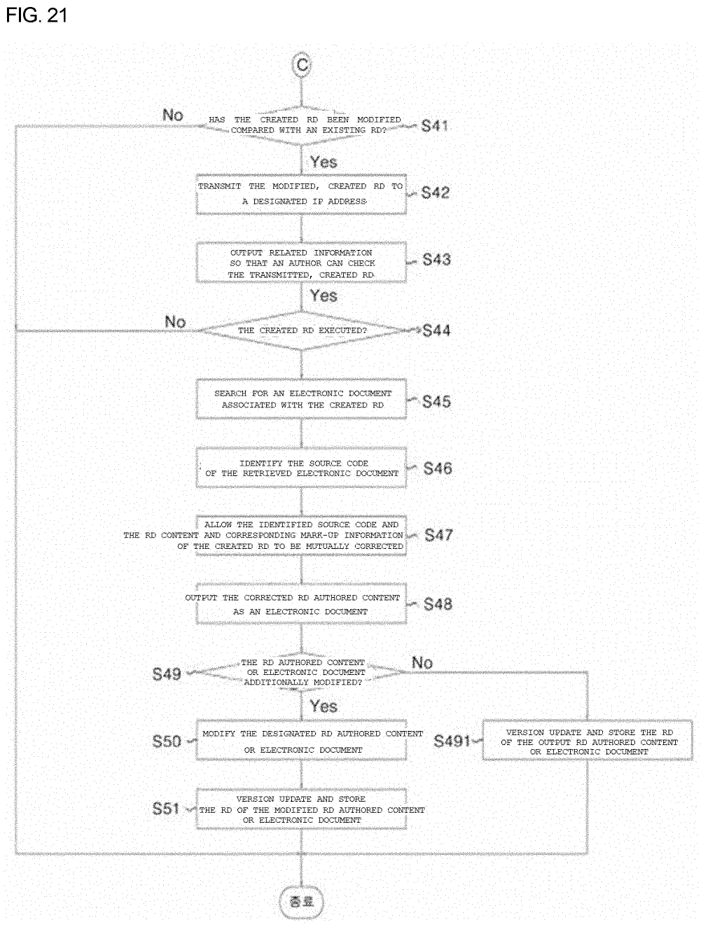

FIG. 21 is a flowchart illustrating a process in which an author receives and works on an RD stored in an RDDB for the purpose of collaboration in an authoring management system as an example according to the present invention.

Referring to FIGS. 15, and 19 to 21, when the RD is generated through the modification of the RD authored content by the user, the modification module 48′ checks whether the generated RD has been changed by comparing the generated RD with the existing RD at step S41. When the change is identified, the collaboration module 47′ transmits the generated RD to a designated IP address so that the author can check it at step S42. The collaboration module 47 of the client terminal that has received the generated RD outputs the received generated RD to the notification window or work window of the authoring module 11 in the form of a list, so that the author recognizes the occurrence of the generated RD at step S43.

When the author checks the output generated RD and agrees to the execution thereof at step S44, the search module 43 searches the electronic document DB 32 for the electronic document associated with the generated RD at step S45. As for the RD configured in the electronic document, the identification information thereof is linked with the unique code of the electronic document, so that the corresponding electronic document is searched based on this.

When the electronic document is searched, the collaboration module 47 identifies the source code of the electronic document at step S46, and corrects the RD content and corresponding mark-up information of the generated RD at step S47. The above correction is intended to allow the source code of the electronic document and the RD authored content to be coordinated with each other so that the RD authored content of the generated RD is combined with the source code of the electronic document and posted on the electronic document without mutual conflict. In the present embodiment, the collaboration module 47 checks the RD authored content of the existing RD linked with the RD authored content of the generated RD based on the corresponding identification information, replaces the RD authored content of the generated RD with the RD authored content of the existing RD, and coordinates the conflicting source code and RD authored content of the generated RD through the above replacement. However, the present embodiment is merely an embodiment, and the step S47 of mutually correcting the electronic document and the RD authored content of the generated RD may be performed in various ways.

When the RD authored content of the generated RD is applied to the source code of the electronic document, the RD content is output to the electronic document in the format of corrected mark-up information at step S48.

The author may check the RD content of the generated RD output to the electronic document, and may modify the output format of the RD content according to the style of the author at step S49. Accordingly, the author may change the RD content edited or written by another user to a style that he or she has and may apply it to his or her electronic document at step S50.

When the modification of the RD authored content by the author is completed, the corresponding RD as well as the RD of the electronic document is version updated and stored in the RDDB 31 and the electronic document DB 32. The version-updated RD is transmitted and stored in the RDDB 31′ of the relation server at step S51.

Meanwhile, the author may refuse to use the generated RD that another user worked on and sent, and may provide notification to the user who edited and sent the RD authored content and/or other users belonging to a collaboration group. The notification may be made through the notification process or chatting process of the authoring management system.

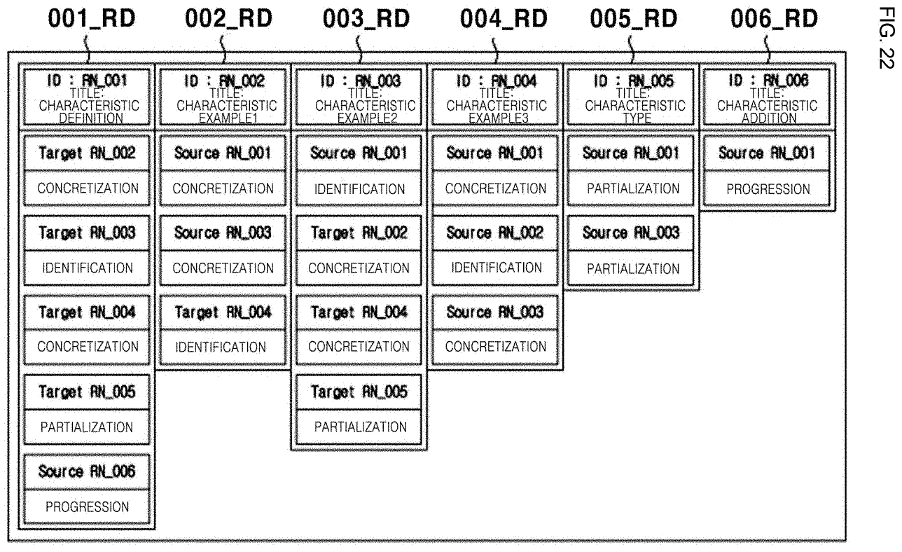

FIG. 22 shows the summary information of RDs as an example illustrating an authoring management method using RDs according to the present invention. In this case, the RD summary information includes identification information, a correlation, and a relation attribute. The source ID and the target ID are a correlation of an RD depending on being designated or designating, and ‘identification,’ ‘concretization,’ ‘partialization,’ and ‘progression’ are relation attributes. Each of the relation attributes has the same meaning as the example of the relation attribute described with reference to FIG. 11. Furthermore, six pieces of RD information are used for convenience of description. For convenience of description, an RD the ID of which is RN_001 is referred to as ‘001_RD,’ an RD the ID of which is RN_002 is referred to as ‘002_RD,’ an RD the ID of which is RN_003 is referred to as ‘003_RD,’ an RD the ID of which is RN_004 is referred to as ‘004_RD,’ an RD the ID of which is RN_005 is referred to as ‘005_RD,’ and an RD the ID of which is RN_006 is referred to as ‘006_RD.’

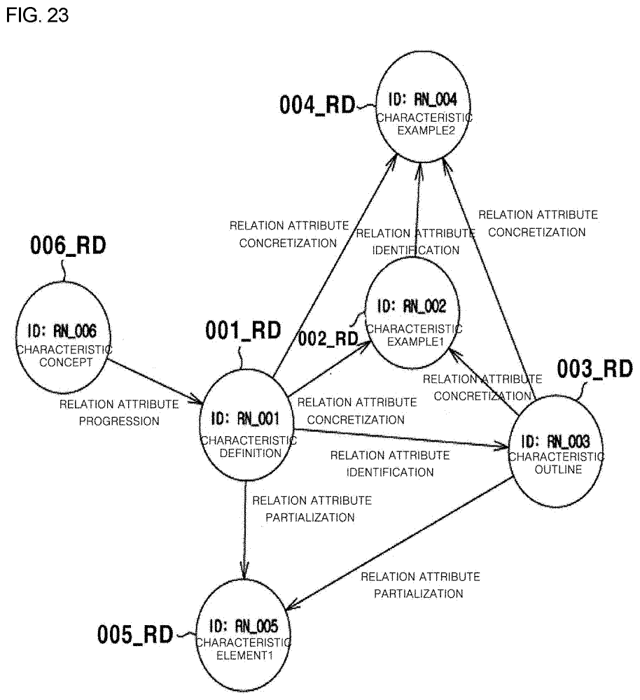

FIG. 23 is a diagram visually representing the summary information shown in FIG. 22 using nodes and edges. In this case, each of the nodes represents the object information of an RD as an example, and each of the edges represents the flow information and correlation between pieces of RD authored content. The content included in the node includes an ID and a title as the information of a corresponding RD, and the edge represents flow information and a correlation using a relation attribute and an arrow. The diagram composed of the nodes and edges is represented in a multidimensional form, such as a two-dimensional (2D) form or a three-dimensional (3D) form, and is frequently used in various fields. In the case of the authoring management system according to the present invention, RDs may be freely and conveniently generated for an overall document, paragraphs, sentences, phrases, words, and/or the like, converted into data, and then managed. When the RD according to the present invention is applied to the node/edge diagram, it may be immediately and effectively used for analysis, verification, etc.

Referring to FIG. 22, 001_RD is related with 002_RD, 003_RD, 004_RD, 005_RD, and 006_RD by the correlation of the target ID and the relation attributes ‘concretization,’ ‘identification,’ ‘concretization,’ ‘partialization,’ and ‘progression.’ This means that the RD authored content of 002_RD, 003_RD, 004_RD, 005_RD, and 006_RD has been changed to the characteristics of ‘concretization,’ identification,’ ‘partialization,’ and ‘progression’ based on the RD authored content of 001_RD. This is visualized as shown in FIG. 23.

Furthermore, 001_RD is related with 006_RD by the correlation of the source ID and the relation attribute ‘progression.’ This means that the RD authored content of 001_RD has been changed to the characteristic ‘progression’ based on the RD authored content of 006_RD. This is visualized as shown in FIG. 23.

Referring to FIG. 22, 002_RD is related with 001_RD and 003_RD by the correlation of the source ID and the relation attribute ‘concretization.’ This means that the RD authored content of 002_RD has been changed to the characteristic ‘concretization’ based on the RD authored content of 001_RD and 003_RD. Furthermore, 002_RD is related with 004_RD by the correlation of the target ID and the relation attribute ‘identification.’ This means that the RD authored content of 004_RD has been changed to characteristic ‘identification’ based on the RD authored content of 002_RD. This is visualized as shown in FIG. 23.

Referring to FIG. 22, 003_RD is related with 001_RD by the correlation of the source ID and the relation attribute ‘concretization.’ This means that the RD authored content of 003_RD has been changed to the characteristic ‘concretization’ based on 001_RD. Furthermore, 003_RD is related with 002_RD and 004_RD by the correlation of the target ID and the relation attribute ‘concretization.’ This means that the RD authored content of 002_RD and 004_RD has been changed to the characteristic ‘concretization’ based on the RD authored content of 003_RD. This is visualized as shown in FIG. 23. Furthermore, 003_RD is related with 005_RD by the correlation of the target ID and the relation attribute ‘partialization.’ This means that the RD authored content of 005_RD has been changed to the characteristic ‘partialization’ based on the RD authored content of 003_RD. This is visualized as shown in FIG. 23.

Referring to FIG. 22, 004_RD is related with 001_RD, 002_RD and 003_RD by the correlation of the source ID and the relation attributes ‘concretization,’ ‘identification’ and ‘concretization.’ This means that the RD authored content of 004_RD has been changed to the characteristics ‘concretization,’ ‘identification’ and ‘concretization’ based on the RD authored content of 001_RD, 002_RD and 003_RD. This is visualized as shown in FIG. 23.

Referring to FIG. 22, 005_RD is related with 001_RD and 003_RD by the correlation of the source ID and the relation attribute ‘partialization.’ This means that the RD authored content of 005_RD has been changed to the characteristic ‘partialization’ based on the RD authored content of 001_RD and 003_RD. This is visualized as shown in FIG. 23.

Referring to FIG. 22, 006_RD is related with 001_RD by the correlation of the source ID and the relation attribute ‘progression.’ This means that the RD authored content of 001_RD has been changed to the characteristic ‘progression’ based on the RD authored content of 006_RD. This is visualized as shown in FIG. 23.

As described above, when RDs are generated for an overall document, paragraphs, sentences, phrases, and/or words, respectively, converted into data, stored and managed according to the present invention, it is possible to clearly review/analyze the change flow of each piece of RD authored content. In addition, even in the case where a project is performed in a recent server-client environment for sharing and collaboration, complicatedly related RD authored content is stratified or subdivided, so that it is possible to manage multiple and/or large quantities of electronic documents in an integrated manner and flexible document management or authoring management is provided, with the result that a working environment may be improved and an economical authoring environment may be provided. Unlike conventional methods that rely on individual research documents, research notes, and individual intellectual management by researchers, the present invention may check and track research progress at all times and also perform partial or full verification, review, and analysis based on revision at all times between authors or organizations through semantic-based correlation review and verification, thereby enabling efficient project progress and management. Accordingly, it is preferable that the authoring management system according to the present invention enables individual-level document authoring and management and also the authoring management system according to the present invention may be applied to large-scale tasks within an organization, between organizations, and at a society level.

Meanwhile, in the case of the authoring management method and authoring management system according to the present invention, RD authored content is organically related to each other by RDs, and thus it is effective in recommending or verifying the RD authored content. This will be described with reference to FIG. 23.

A process of verifying 001_RD and 005_RD will be described with reference to FIG. 23. The RD authored content of the 001_RD is related with the ‘identification’ of the RD authored content of 003_RD and the RD authored content of 005_RD is related with the ‘partialization’ of the RD authored content of 003_RD, with the result that the RD authored content of 005_RD needs to be related with the ‘partialization’ of the RD authored content of 001_RD. Nevertheless, when a relation attribute other than ‘partialization’ such as ‘progression’ or ‘concretization’ is designated as the relation attribute in the process of creating 005_RD, this corresponds to inconsistency. In this case, the authoring management system according to the present invention determines that the verification result is ‘inconsistency,’ and then recommends the relation attribute ‘partialization’ to the author or informs the author of the inconsistency so that it can be reviewed and reset.

Next, a process of verifying 001_RD and 002_RD will now be discussed. The RD authored content of 001_RD corresponds to the ‘identification’ of the RD authored content of 003_RD and the RD authored content of 002_RD has the characteristic of the ‘concretization’ of the RD authored content of 003_RD, with the result that the RD authored content of 002_RD needs to have the characteristic of the ‘concretization’ of the RD authored content of 001_RD.

Furthermore, a process of verifying 001_RD and 004_RD will now be discussed. The RD authored content of 002_RD has the characteristic of the ‘concretization’ of the RD authored content of 001_RD and the RD authored content of 002_RD corresponds to the ‘identification’ of the RD authored content of 004_RD, with the result that the RD authored content of 004_RD needs to have the characteristic of the ‘concretization’ of the RD authored content of 001_RD.

Furthermore, a process of verifying 003_RD and 004_RD will now be discussed. The RD authored content of 002_RD has the characteristic of the ‘concretization’ of the RD authored content of 003_RD and the RD authored content of 002_RD corresponds to the ‘identification’ of the RD authored content of 004_RD, with the result that the RD authored content of 004_RD needs to have the characteristic of the ‘concretization’ of the RD authored content of 003_RD.

Furthermore, a process of verifying 001_RD and 004_RD will now be discussed. the RD authored content of 002_RD has the characteristic of the ‘concretization’ of the RD authored content of 001_RD and the RD authored content of 002_RD corresponds to the ‘identification’ of the RD authored content of 004_RD, with the result that the RD authored content of 004_RD needs to have the characteristic of the ‘concretization’ of the RD authored content of 003_RD.

Next, a verification process in the case where the relation attributes of verification targets overlap each other will now be discussed. Referring back to the above-described process of verifying 001_RD and 004_RD, 001_RD and 004_RD may be verified through not only the route of 001_RD and 003_RD but also the route of 003_RD and 004_RD.

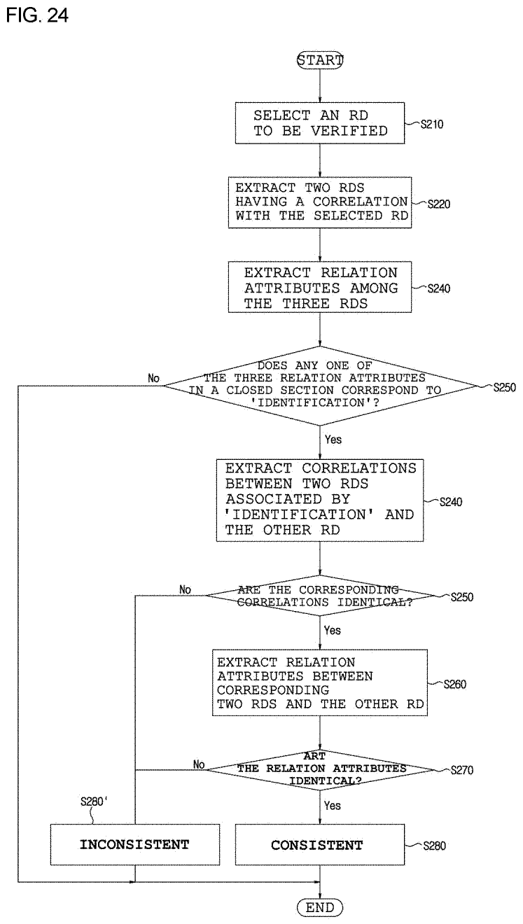

As described above, in the case where three RDs have correlations in the authoring management system according to the present invention, even when machine learning to be described below is not applied, an error in the relation attribute may be easily determined by a program and then verification or recommendation may be performed. Furthermore, as the correlations of RDs increase, verification routes increase, so the validity of verification increases. This will be described with reference to FIG. 24.

FIG. 24 is a flowchart showing a process illustrating the relation attribute verification process of an authoring management system as a preferred example according to the present invention.

Referring to FIGS. 23 and 24, the authoring management system according to the present invention selects an RD having a relation attribute to be verified at step S210. The authoring management system according to the present invention requires verification when an author desires to designate or recommend a relation attribute or a relation attribute is automatically set. For this purpose, an RD 001_RD having a relation attribute to be verified is selected and extracted.

When the corresponding RD 001_RD is selected, the data processing module 23 (see FIG. 3) extracts two RDs 002_RD and 003_RD having a correlation with the selected RD 001_RD at step S220, and determines whether or not the selected RD 001_RD corresponds to a closed section. In this case, when the selected RD 001_RD have correlations with the extracted two RDs 002_RD and 003_RD, it is determined that a closed section is formed.

When the selected RD 001_RD is not configured in the closed section, verification is terminated, and verification is performed by a learning modeling method to be described later. In addition, when the selected RD 001_RD is configured in a closed section, a correlation is extracted from the extracted two RDs 002_RD and 003_RD. Furthermore, a correlation having the relation attribute ‘identification’ is extracted from the closed section of the selected RD 001_RD at step S240.

Whether or not correlations are the same is determined based on the directionality of two RDs. Accordingly, the correlation between 001_RD and 002_RD and the correlation between 002_RD and 003_RD are the same.

When it is determined at step S250 that the correlations are the same, the relational attributes of the corresponding two RDs 001_RD and 003_RD and the other RD 002_RD are extracted at step S260.

In this case, ‘identification,’ which is one of the relation attributes, does not refer to the meaning of the substantive, semantic, or morphological identification of RD authored content, but refers to a relation attribute as the characteristic of the change of the RD authored content. When the relation attribute ‘identification’ is defined as a case where a sematic and/or morphological change in RD authored content is insignificant and thus two RDs fall within a substantially same category, this case may be determined to have the relation attribute ‘identification.’

When, as a result of the verification, the relation attributes are the same at step S270, it is determined that the result of the verification is consistency at step S280. When the relation attributes are not the same, it is determined that the result of the verification is inconsistency at step S280′.

In the present embodiment, the relation attributes of 001_RD and 002_RD and the relation attributes of 002_RD and 003_RD are the same as ‘concretization,’ and thus it is determined as a result of the verification that the relation attributes among 001_RD, 002_RD and 003_RD constituting a closed section are consistent with each other.

First, machine learning will now be discussed. Generally, machine learning includes supervised learning, unsupervised learning, and semi-supervised learning. Unsupervised learning, represented by clustering, does not require a learning label (target value) or training data, whereas semi-supervised learning or supervised learning requires a learning label and training data because it is a learning method that finds output that fits input. Although examples of the supervised learning include decision trees, support vector machines, and artificial neural networks, interest in XGBoost or deep learning is increasing recently. Recently, Generative Adversarial Networks (GANs) have been attracting attention, but leave many challenges in the field of natural language processing. In spite of such numerous learning models, refined learning data is very important for machine learning.

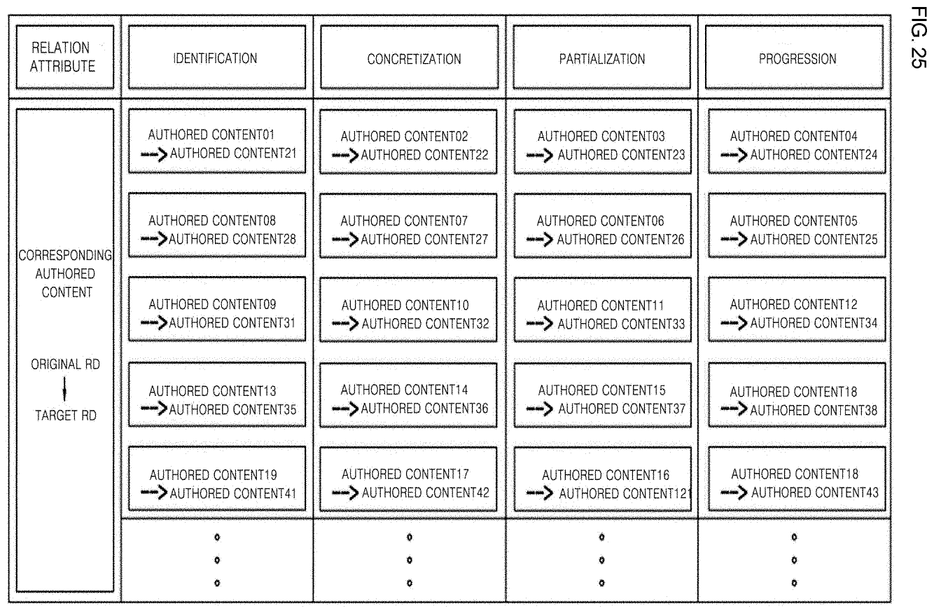

FIG. 25 schematically shows a table of relation attributes and RD authored content of RDs as a preferred example according to the present invention. In this case, for convenience of description and understanding, RD authored content and relation attributes are arbitrarily marked.

Referring to FIG. 25, relation attributes are allocated as the column names to the table, and pieces of RD authored content are located for each relation attribute. In this case, the relation attributes and the RD authored content are the data designated by the author when the RDs are created. The relation attributes and the RD authored content may be viewed as reflecting and expressing the connection between the thoughts of an author. Accordingly, the relation attributes and RD authored content of the table may be beneficially used as refined learning data. Moreover, when RD authored content and relation attributes are verified by the verification process described with reference to FIG. 24 and also data is classified/organized as RDs are accumulated, there may be obtained data that is beneficial as learning data that can train a model. This means that the labor of collecting refined learning data, which is essential for classification of machine learning, may be avoided.

Furthermore, the author may refer to the history of relation attributes between the original and target RDs designated by himself or herself to designate a subsequent relation attribute while storing and managing the history of relation attributes. The relation setting module 22 may determine the relation attribute setting pattern of the corresponding author from the cumulative data. Furthermore, the relation setting module 22 may automatically set a relation attribute according to the setting pattern of the author determined as described above.

Furthermore, although machine learning models applicable to the authoring management system according to the present invention may be various, a convolutional neural network (CNN) model is preferable because a CNN is recently widely used as a text classifier in the field of natural language processing as a deep learning model. The CNN model may be implemented by open source software such as Google's Tensor Flow and Keras, Apache MXNet, Microsoft's CNTK, and Facebook's Caffe. In other words, the relation attributes of the RD authored content of a verification target RD may be predicted by selecting a CNN model, arranging training data (relation attributes, and RD authored content), fitting the training data to the model (CNN), and applying the verification target RD to the trained model. Since a specific method using the CNN model is well known in the field of the present invention, a detailed description thereof will be omitted below.

As described above, the authoring management method and authoring management system according to the present invention have been described in more detail, but this is illustrated and described as examples. It is obvious that those having ordinary skill in the art to which the present invention pertains may freely and variously make modifications within the scope of the technical spirit of the present invention. Therefore, the scope of protection of the present invention should not be construed as being limited to the detailed description of the invention or the accompanying drawings, but should be defined by the appended claims.

1. An authoring management method comprising:
a content designated section setting step of setting a designated section in an electronic document by an input key of an input device;
an RD authored content collection step of collecting first RD content and corresponding first mark-up information located in the designated section as first RD authored content;
an identification information creation step of creating identification information of the first RD authored content;
a correlation collection step of collecting a correlation between the first RD authored content and another piece of RD authored content;
a relation attribute collection step of collecting a relation attribute regarding a nature of a change between the first authored RD content and the other piece of authored RD content;
an RD creation step of creating a first RD by converting the first RD authored content, the identification information, the correlation, and the relation attribute into a dataset; and
a storage step of storing the first RD in an RDDB and also storing the electronic document in an electronic document DB.

2. The authoring management method of claim 1, wherein at the RD authored content collection, the first RD content and the corresponding first mark-up information are collected separately.

3. The authoring management method of claim 2, wherein the RD authored content collection step comprises:
allocating a first identification code to the first RD content;
inserting the first identification code into a corresponding section of the first mark-up information; and
separating the first RD content into which the first identification code is inserted and the corresponding first mark-up information.

4. The authoring management method of claim 3, further comprising:
extracting the first RD content of the first RD retrieved from the RDDB; and
outputting the extracted first RD content in a basic format.

5. The authoring management method of claim 4, further comprising, when the first RD content is modified, creating second RD content and storing it as a second RD.

6. The authoring management method of claim 5, further comprising:
checking for a change in the second RD content based on the first RD content; and
transmitting the second RD to a designated IP address when the change in the second RD content is identified.

7. The authoring management method of claim 6, further comprising:
checking an electronic document linked to the second RD for a source code thereof when the electronic document linked to the second RD is retrieved from the electronic document DB;
mutually correcting the source code, the second RD content of the second RD, and corresponding second mark-up information; and
performing processing so that the corrected second RD authored content can be posted on the electronic document.

8. The authoring management method of claim 3, further comprising:
extracting the first RD content and corresponding first mark-up information of the first RD retrieved from the RDDB;
combining the identification code inserted into the first mark-up information through replacement with the corresponding first RD content; and
combining the extracted first RD content with the corresponding first mark-up information, and outputting a result of the combination.

9. The authoring management method of claim 8, further comprising, when the first RD content and the corresponding first mark-up information are modified, creating third RD content and corresponding third mark-up information and storing them as a third RD.

10. The authoring management method of claim 1, further comprising combining the first RD content of the first RD retrieved from the RDDB with the corresponding first mark-up information and then outputting a result of the combination.

11. The authoring management method of claim 10, further comprising, when the output first RD content and corresponding first mark-up information are modified, creating fourth RD content and corresponding fourth mark-up information and storing them as a fourth RD.

12. An authoring management system comprising:
an authoring module configured to create RD content of an electronic document according to input information of an input device;
an RD definition module configured to allocate identification information to a designated section of the RD content and classify the RD content and corresponding mark-up information as RD authored content;
a relation setting module configured to collect a correlation between the RD authored content and another piece of RD authored content and collect a relation attribute regarding a nature of a change between the RD authored content and the other piece of RD authored content; and
a data processing module configured to create an RD by converting the RD authored content, the identification information, the correlation, and the relation attribute into a dataset, and store the RD in an RDDB and the electronic document in an electronic document DB.

13. The authoring management system of claim 12, wherein the authoring management system constitutes a network environment in which a client and a server communicate with each other, the RDDB is formed in at least one of the client and the server, and the electronic document DB is formed in the client.

14. The authoring management system of claim 12, wherein the electronic document DB is further formed in the server.

15. The authoring management system of claim 13, wherein the electronic document DB is further formed in the server.
